(19) United States
(12) Patent Application Publication
(10) Pub. No.: US 2012/0274874 A1
(43) Pub. Date: Nov. 1, 2012

(54) Backlight Module and Liquid Crystal Display Device

(75) Inventors: Po-Ying Lin, Shenzhen City (CN); Weiwei Zheng, Shenzhen City (CN)

(73) Assignee: Shenzhen China Star Optoelectronics Technology Co. LTD., Shenzhen City, Guangdong (CN)

(21) Appl. No.: 13/375,452

(22) PCT Filed: Aug. 22, 2011
(86) PCT No.: PCT/CN11/78699

§ 371 Date: Nov. 30, 2011

(30) Foreign Application Priority Data
Apr. 29, 2011 (CN) 201110111846.9

(51) Int. Cl. G02F 1/13357; F21V 13/02

(52) U.S. Cl. 349/62; 362/608

(57) ABSTRACT

A backlight module is provided in the present disclosure. The backlight module comprises a light guide panel and at least one point light source adapted to provide light rays for the light guide panel. The light guide panel comprises a primary light guide region and a secondary light guide region with respect to the point light source, and a plurality of scattering microstructures are disposed in the secondary light guide region to scatter the light rays entering the secondary light guide region. The backlight module features uniform intensity and can significantly reduce or even eliminate occurrence of the so-called hotspot phenomenon. A liquid crystal display (LCD) device using the backlight module is also provided.

### FIELD OF THE INVENTION

The present disclosure generally relates to the technical field of liquid crystal displaying, and more particularly, to a backlight module and a liquid crystal display (LCD) device using the backlight module.

### BACKGROUND OF THE INVENTION

Owing to their advantages such as light weight, a thin profile, low power consumption and a low radiation level, liquid crystal display (LCD) devices have found wide application in computer monitors, television (TV) sets, notebook computers, mobile phones, digital cameras (DCs) and other electronic products. However, because liquid crystal panels of the LCD devices are unable to emit light by themselves, backlight modules are needed to provide surface light sources for the LCD devices.

In the prior art, backlight modules generally falls into two categories, namely, the edge-lit backlight modules and the direct-lit backlight modules. An edge-lit backlight module requires use of a light guide panel (LGP) and a light source (e.g., a cold cathode fluorescent lamp (CCFL) or light emitting diodes (LED)) disposed at an edge of the light guide panel. As the LED is a kind of point light source, usually a plurality of LEDs must be disposed at the edge of the light guide panel. Furthermore, light rays emitted from the LEDs onto the light guide panel follow a lambertian profile; i.e., light rays within a certain angular range (e.g., a half-intensity region) are uniform and have a high intensity, but light rays outside the certain angular range (e.g., the half-intensity region) become extremely non-uniform and have an abruptly decreased intensity. As non-half-intensity regions of adjacent LEDs overlap with each other, the non-uniform light fields are superimposed on each other to form regions having an even more non-uniform intensity, which are called hotspot regions. The hotspot regions have a significant influence on imaging quality of the LCD device.

### SUMMARY OF THE INVENTION

A primary objective of the present disclosure is to provide a backlight module and a liquid crystal display (LCD) device, which can reduce or eliminate occurrence of the hotspot phenomenon in the light guide panel so as to improve the displaying quality of the backlight module and the LCD device that use the light guide panel.

To achieve the aforesaid objective, the present disclosure provides a backlight module, which comprises a light guide panel and at least one point light source adapted to provide light rays for the light guide panel. The light guide panel comprises a primary light guide region and a secondary light guide region with respect to the point light source. The primary light guide region is a sector region that has a certain included angle with the point light source as an origin and that extends toward an inside of the light guide panel, and is also a region where an intensity of the incident light rays is greater than a half of a maximum intensity of the point light source. The secondary light guide region is located at both sides of the primary light guide region and is a region where an intensity of the incident light rays is smaller than a half of the maximum intensity of the point light source, and a plurality of scattering microstructures are disposed in the secondary light guide region to scatter the light rays entering the secondary light guide region.

To achieve the aforesaid objective, the present disclosure provides also a backlight module, which comprises a light guide panel and at least one point light source adapted to provide light rays for the light guide panel. The light guide panel comprises a primary light guide region and a secondary light guide region with respect to the point light source, and a plurality of scattering microstructures are disposed in the secondary light guide region to scatter the light rays entering the secondary light guide region.

According to a preferred embodiment of the present disclosure, the primary light guide region is a sector region that has a certain included angle with the point light source as an origin and that extends toward an inside of the light guide panel, and the secondary light guide region is disposed at both sides of the primary light guide region.

According to a preferred embodiment of the present disclosure, the primary light guide region is a region where an intensity of the incident light rays is greater than a half of a maximum intensity of the point light source, and the secondary light guide region is a region where an intensity of the incident light rays is smaller than a half of the maximum intensity of the point light source.

According to a preferred embodiment of the present disclosure, the scattering microstructures are adapted to enlarge a divergence angle of the light rays entering the secondary light guide region and to uniformize the intensity of the light rays entering the secondary light guide region.

According to a preferred embodiment of the present disclosure, cross sections of the scattering microstructures are selected from the group consisting of a triangular form, a rectangular form, a polygonal form, a circular form, a semi-circular form, a sector form and an irregular form.

According to a preferred embodiment of the present disclosure, the scattering microstructures are of a hollow structure and/or a structure filled with a scattering material.

According to a preferred embodiment of the present disclosure, the cross-sections of the scattering microstructures are in a sector form, and an apex angle of the sector faces toward the point light source.

According to a preferred embodiment of the present disclosure, a distribution density of the scattering microstructures is positively correlated with a distance from the point light source.

According to a preferred embodiment of the present disclosure, the cross sections of the scattering microstructures are in a rectangle form, and a short side of the rectangle faces toward the point light source.

To achieve the aforesaid objective, the present disclosure further provides a liquid crystal display (LCD) comprising a backlight module. The backlight module comprises a light guide panel and at least one point light source adapted to provide light rays for the light guide panel. The light guide panel comprises a primary light guide region and a secondary light guide region with respect to the point light source, and a plurality of scattering microstructures are disposed in the secondary light guide region to scatter the light rays entering the secondary light guide region.

According to a preferred embodiment of the present disclosure, the primary light guide region is a sector region that has a certain included angle with the point light source as an origin and that extends toward an inside of the light guide panel, and the secondary light guide region is disposed at both sides of the primary light guide region.

According to a preferred embodiment of the present disclosure, the primary light guide region is a region where an intensity of the incident light rays is greater than a half of a maximum intensity of the point light source, and the secondary light guide region is a region where an intensity of the incident light rays is smaller than a half of the maximum intensity of the point light source.

According to a preferred embodiment of the present disclosure, the scattering microstructures are adapted to enlarge a divergence angle of the light rays entering the secondary light guide region and to uniformize the intensity of the light rays entering the secondary light guide region.

According to a preferred embodiment of the present disclosure, cross sections of the scattering microstructures are selected from the group consist of a triangular form, a rectangular form, a polygonal form, a circular form, a semi-circular form, a sector form and an irregular form.

According to a preferred embodiment of the present disclosure, the scattering microstructures are of a hollow structure and/or a structure filled with a scattering material.

According to a preferred embodiment of the present disclosure, the cross-sections of the scattering microstructures are in a sector form, and an apex angle of the sector faces toward the point light source.

According to a preferred embodiment of the present disclosure, a distribution density of the scattering microstructures is positively correlated with a distance from the point light source.

According to a preferred embodiment of the present disclosure, the cross sections of the scattering microstructures are in a rectangle form, and a short side of the rectangle faces toward the point light source.

The present disclosure has the following benefits: as the scattering microstructures in the light guide panel allow incident rays outside the half-intensity region to be scattered into a larger angular range, uniformity of the light rays outside the half-intensity region is improved and intensity of emergent light rays outside the half-intensity region is enhanced. Thus, when light rays outside the same half-intensity region that are from adjacent point light sources overlap with each other, uniformity of the light rays can be improved and intensity of the light rays outside the half-intensity region becomes closer to that of light rays within the half-intensity region. Thereby, occurrence of the hotspot phenomenon is significantly reduced or even eliminated, and the displaying quality of the backlight module and the LCD device is improved.

### BRIEF DESCRIPTION OF THE DRAWINGS

In order to more clearly describe the technical solutions of the embodiments of the present disclosure, attached drawings to be used in the detailed description of the disclosure will be briefly described hereinbelow. Obviously, the attached drawings described hereinbelow only illustrate some of the embodiments of the present disclosure, and those of ordinary skill in the art can also obtain other attached drawings therefrom without the need of making inventive efforts, wherein:

FIG. 1 is a schematic structural view of a first embodiment of a backlight module according to the present disclosure.

FIG. 2 is a schematic structural view of a second embodiment of the backlight module according to the present disclosure.

FIG. 3 is a schematic structural view of a third embodiment of the backlight module according to the present disclosure.

FIG. 4 is a schematic structural view of a fourth embodiment of the backlight module according to the present disclosure.

FIG. 5 is a schematic structural view of a fifth embodiment of the backlight module according to the present disclosure.

FIG. 6 is a schematic structural view of a sixth embodiment of the backlight module according to the present disclosure.

### DETAILED DESCRIPTION OF THE INVENTION

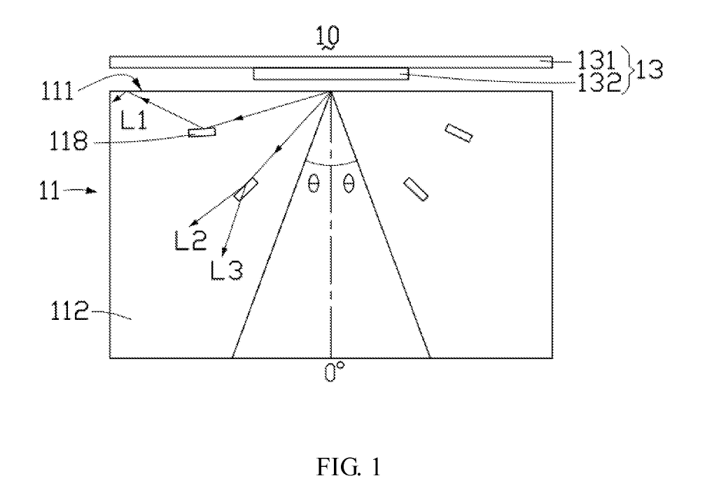

Referring to FIG. 1, there is shown a schematic structural view of a first embodiment of a backlight module according to the present disclosure. As shown in FIG. 1, the backlight module 10 comprises a light guide panel 11 and a light source 13 used in conjunction with the light guide panel 11 to provide light rays for illumination. The backlight module 10 may further comprise optical sheets having other functions such as a diffuser sheet, a prism sheet or the like, which will not be further described herein.

In this embodiment, the light source 13 is an LED bar, including an LED installing bar 131 and one or more LEDs 132. The LEDs 132 are arranged on the LED installing bar 131 regularly at intervals.

The light guide panel 11 is not limited in shape, and may be made of a transparent material of a rectangular shape, a wedge shape or even an irregular shape. The light guide panel 11 at least comprises a light incident surface 111, a light emergent surface 112 substantially perpendicular to the light incident surface 111, and a bottom surface (not labeled) opposite to the light incident surface. The light source 13 is disposed at the side of the light incident surface 111 of the light guide panel 11 with the LEDs 132 facing toward the light incident surface 111 so that light rays emitted by the LEDs 132 are directed into the light guide panel 11. Then, the light rays received from the LEDs 132 are optically re-distributed by the light guide panel 11 to form light rays emerging from the light emergent surface 112 uniformly.

It is worth noting that, for convenience of describing this embodiment, only one LED 132 and a portion of the light guide panel 11 corresponding to the one LED 132 are depicted in the backlight module 10 of FIG. 1; and other portions of the light guide panel 11 corresponding to other LEDs 132 are just the same in both structure and arrangement, so they will not be further described herein.

Although each of the LEDs 132 has a certain area, it may be viewed as a point light source in practical arrangement because of its small area. Generally, light rays emerging from the LED 132 is distributed in a sector form, and what can be effectively utilized is typically a half-intensity region thereof (i.e., a sector region in which the light intensity is attenuated to a half of the maximum intensity).

Further, light rays of the half-intensity region emitted by the LED 132 enter the light guide panel 11 through the light incident surface 111. As the light rays are refracted in the air and on a base surface of the light guide panel 11, a half-intensity region different from that in the air is formed in a region of the light guide panel 11 that faces directly toward the LED 132. Presuming that the included angle of the half-intensity region of the LED 132 in the air is 60° and the included angle of the half-intensity region in the light guide panel 11 is ±θ°, then the included angle of the half-intensity region in the light guide panel 11 may be calculated according to the following Equation (1):

$$\frac{sin 60}{sin θ} = \frac{{n}_{LGP}}{{n}_{air}} \qquad ( 1 )$$

where, n_{LGP} represents the refractive index of the light guide panel 11, nₐᵢᵣ represents the refractive index of the air, and θ represents the included angle of the half-intensity region in the light guide panel 11.

If the light guide panel 11 is made of a polymethyl methacrylate (PMMA) material having a refractive index of 1.48, then

$$\frac{sin 60}{sin θ} = \frac{{n}_{LGP}}{{n}_{air}} = \frac{1.48}{1}$$

$$θ = 35.81 °$$

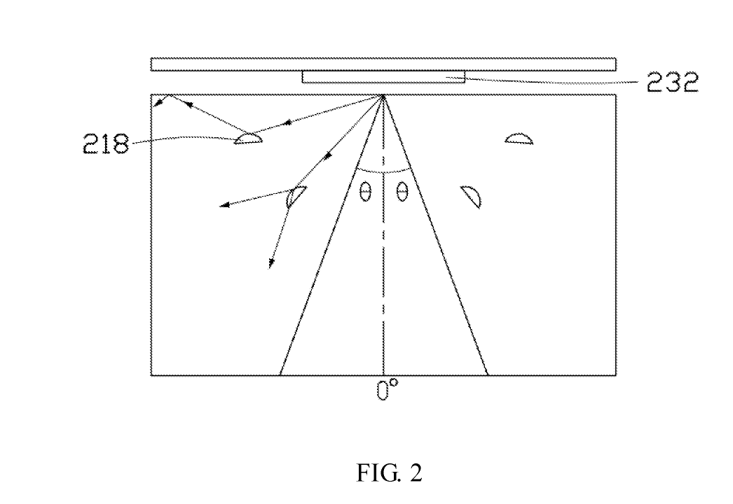

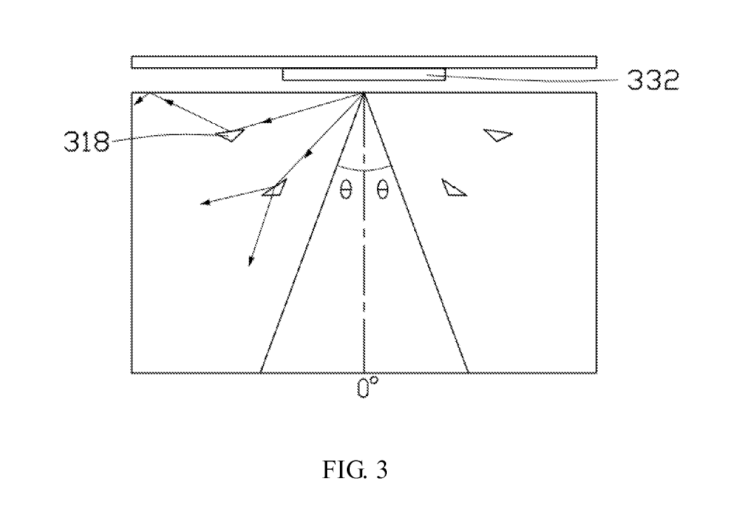

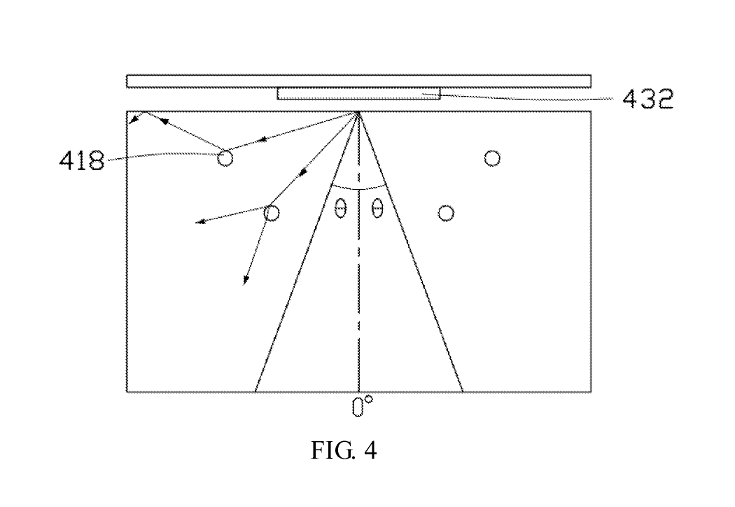

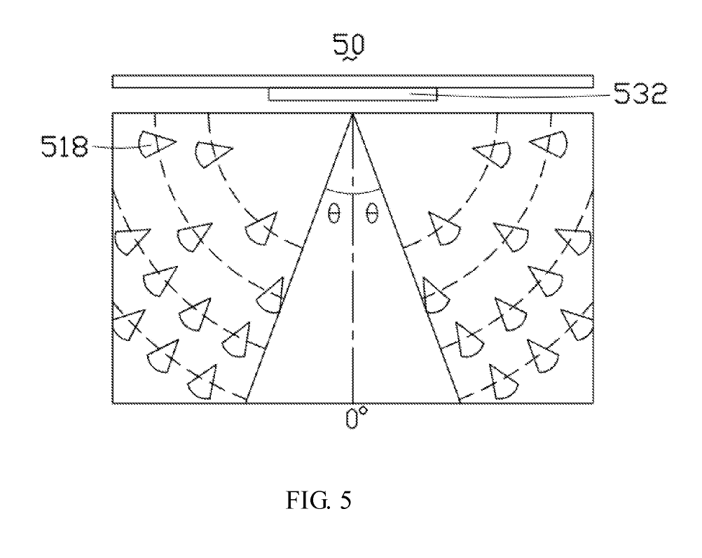

Further, within the half-intensity region (i.e., within the angular range of ±θ°) of the light guide panel 11, the light guide panel 11 is uniform both in material and in structure, and propagation of light rays from the LED 132 is not disturbed in this region, so a more uniform light intensity is formed in this region. In contrast, a plurality of scattering microstructures 118 are disposed outside the half-intensity region (i.e., outside the angular range of ±θ°) in the light guide panel 11. The scattering microstructures 118 may either be air bubble or hollow structures or be made of a transparent or translucent scattering material (e.g., glass, quartz crystal, or a silica gel) that is different from the material of the light guide panel 11 as long as they can scatter light rays. The scattering microstructures 118 may extend through the light guide panel 11. Additionally, the scattering microstructures 118 are not limited in shape; specifically, they may have cross sections of a triangular form, a rectangular form, a polygonal form, a circular form, a semi-circular form, an irregular form or the like (e.g., the scattering microstructures 218, 318, 418, 518 shown respectively in FIG. 2, FIG. 3, FIG. 4 or FIG. 5). For the light guide panel 11 shown in FIG. 1, the region within the half-intensity region may be termed as a primary light guide region, while the region outside the half-intensity region may be termed as a secondary light guide region. By changing the optical arrangement of the secondary light guide region, the purpose of optimizing the light guide effect of the light guide panel 11 can be achieved.

Further, a short side of the cross section of each of the scattering microstructures 118 faces toward the point light source. Specifically, a short side of each of the scattering microstructures 118 having a rectangular cross section shown in FIG. 1 faces toward the LED 132; a sharp corner of each of the scattering microstructures 218 having a semi-circular cross section shown in FIG. 2 faces toward the LED 232; an acute angle of each of the scattering microstructures 318 having a triangular cross section shown in FIG. 3 faces toward the LED 332; and an apex angle of each of the scattering microstructures 518 having a sector cross section shown in FIG. 5 faces toward the LED 532. However, if each of the scattering microstructures has a cross section that is in central symmetry, then they may be freely arranged without being limited to the aforesaid rule; for example, positional relationships between scattering microstructures 418 having a circular cross section and the LEDs 432 are shown in FIG. 4.

When the light rays from the LED 132 enters the outside of the half-intensity region, the light rays are reflected and refracted at an interface between the body of the light guide panel 11 and the scattering microstructures 118 to result in an enlarged angular range of light rays of the LED 132. Specifically, because of the special design of the scattering microstructures 118, the scattered light rays are scattered into a wider angular range as shown by the light rays L1, L2 in FIG. 1. Thus, the reflected light rays L1, L2 are reflected at a larger angle into a wider scattering region, as a result of which the divergence angle outside the half-intensity region of the LED 132 becomes larger and light rays are distributed therein more uniformly. For light rays refracted by the scattering microstructures 118 as shown by the light rays L3 in FIG. 1, the divergence angle of the refracted light rays can also be made larger by optimizing the structure of the scattering microstructures 118; furthermore, when the refractive index of the scattering microstructures 118 is greater than that of the body of the light guide panel 11, total reflection might occur at the interface between the scattering microstructures 118 and the body of the light guide panel 11. The total reflection can also help to reflect the light rays into a wider divergence angle range, which also facilitates uniformity of the light rays outside the half-intensity region.

With the aforesaid arrangement, the scattering microstructures 118 allow the incident light rays outside the half-intensity region to be scattered into a larger angular range, which can improve uniformity of light rays outside the half-intensity region and enhance intensity of light rays emerging from the half-intensity region. Thus, when light rays outside the same half-intensity region that are from adjacent LEDs 132 overlap with each other, uniformity of the light rays is improved and intensity outside the half-intensity region becomes closer to that of the half-intensity region. As a result, occurrence of the hotspot phenomenon is reduced or even eliminated to result in an improved quality of the backlight module 10.

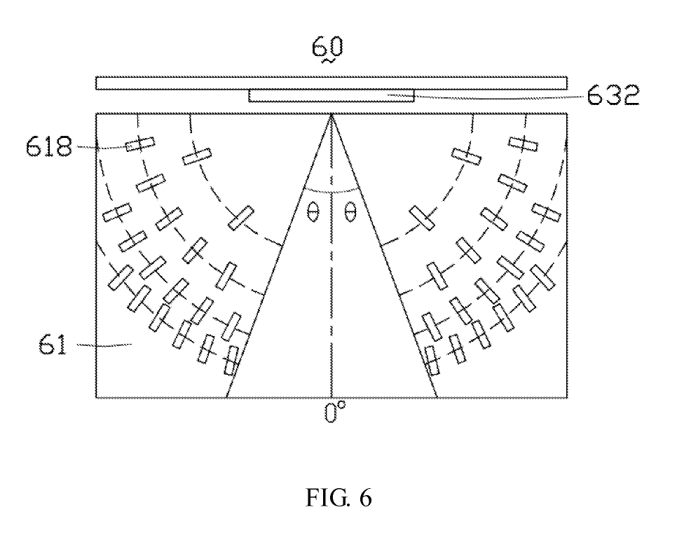

Further, a backlight module 60 according to another embodiment is shown in FIG. 6. The backlight module 60 shown in FIG. 6 is similar to the backlight module 10 in both structure and arrangement, but has the following main difference: the distribution density of scattering microstructures 618 outside the half-intensity region of the light guide panel 61 is positively correlated with a distance from the LED 632; i.e, the closer the scattering microstructures 618 are to the LED 632, the lower the distribution density thereof will be, and conversely, the further the scattering microstructures 618 are from the LED 632, the higher the distribution density thereof will be. Consequently, scattering microstructures 618 closer to the LED 632 present a lower distribution density and the light rays emitted from the LED 632 are less likely to be scattered there, which allows for the light rays emitted from the LED 632 to be propagated to a greater distance. As the propagation distance of the light rays emitted from the LED 632 increases, intensity of the light rays degrades gradually; however, the gradually increasing distribution density of the scattering microstructures 618 helps to enhance scattering of the light rays emitted from the LED 632 so as to increase the probability that the light rays emerge from this region. Thereby, it is ensured that the light rays emitted from the LED 632 are distributed uniformly in this region.

Of course, for design of backlight modules of different specifications, settings of parameters of the scattering microstructures will vary with parameters of the LEDs and the light guide panel in order to render light rays emerging from the outside of the half-intensity region more uniform.

In the aforesaid embodiments, the scattering microstructures may be formed during injection molding of the light guide panel or be formed through a subsequent hollow-out process, and a suitable transparent scattering material may be filled in the hollowed scattering microstructures depending on practical needs.

It is worth noting that, those skilled in the art can determine specific requirements on the backlight module and reasonably alter the specific arrangement of the scattering microstructures to accomplish the present disclosure.

Furthermore, an LCD device using the aforesaid backlight module is provided in the present disclosure. The LCD device comprises an LCD panel and the aforesaid backlight module. The backlight module is disposed adjacent to the LCD panel to provide a uniform surface light source of an adequate intensity for the LCD panel.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A backlight module, comprising a light guide panel and at least one point light source adapted to provide light rays for the light guide panel, wherein: the light guide panel comprises a primary light guide region and a secondary light guide region with respect to the point light source, the primary light guide region is a sector region that has a certain included angle with the point light source as an origin and that extends toward an inside of the light guide panel, and is also a region where an intensity of the incident light rays is greater than a half of a maximum intensity of the point light source, the secondary light guide region is located at both sides of the primary light guide region and is a region where an intensity of the incident light rays is smaller than a half of the maximum intensity of the point light source, and a plurality of scattering microstructures are disposed in the secondary light guide region to scatter the light rays entering the secondary light guide region.

2. A backlight module, comprising a light guide panel and at least one point light source adapted to provide light rays for the light guide panel, wherein the light guide panel comprises a primary light guide region and a secondary light guide region with respect to the point light source, and a plurality of scattering microstructures are disposed in the secondary light guide region to scatter the light rays entering the secondary light guide region.

3. The backlight module of claim 2, wherein the primary light guide region is a sector region that has a certain included angle with the point light source as an origin and that extends toward an inside of the light guide panel, and the secondary light guide region is disposed at both sides of the primary light guide region.

4. The backlight module of claim 2, wherein the primary light guide region is a region where an intensity of the incident light rays is greater than a half of a maximum intensity of the point light source, and the secondary light guide region is a region where an intensity of the incident light rays is smaller than a half of the maximum intensity of the point light source.

5. The backlight module of claim 2, wherein the scattering microstructures are adapted to enlarge a divergence angle of the light rays entering the secondary light guide region and to uniformize the intensity of the light rays entering the secondary light guide region.

6. The backlight module of claim 2, wherein cross sections of the scattering microstructures are selected from the group consisting of a triangular form, a rectangular form, a polygonal form, a circular form, a semi-circular form, a sector form and an irregular form.

7. The backlight module of claim 2, wherein the scattering microstructures are of a hollow structure and/or a structure filled with a scattering material.

8. The backlight module of claim 6, wherein the cross-sections of the scattering microstructures are in a sector form, and an apex angle of the sector faces toward the point light source.

9. The backlight module of claim 2, wherein a distribution density of the scattering microstructures is positively correlated with a distance from the point light source.

10. The backlight module of claim 6, wherein the cross sections of the scattering microstructures are in a rectangle form, and a short side of the rectangle faces toward the point light source.

11. A liquid crystal display (LCD) device comprising a backlight module, the backlight module comprising a light guide panel and at least one point light source adapted to provide light rays for the light guide panel, wherein the light guide panel comprises a primary light guide region and a secondary light guide region with respect to the point light source, and a plurality of scattering microstructures are disposed in the secondary light guide region to scatter the light rays entering the secondary light guide region.

12. The LCD device of claim 11, wherein the primary light guide region is a sector region that has a certain included angle with the point light source as an origin and that extends toward an inside of the light guide panel, and the secondary light guide region is disposed at both sides of the primary light guide region.

13. The LCD device of claim 11, wherein the primary light guide region is a region where an intensity of the incident light rays is greater than a half of a maximum intensity of the point light source, and the secondary light guide region is a region where an intensity of the incident light rays is smaller than a half of the maximum intensity of the point light source.

14. The LCD device of claim 11, wherein the scattering microstructures are adapted to enlarge a divergence angle of the light rays entering the secondary light guide region and to uniformize the intensity of the light rays entering the secondary light guide region.

15. The LCD device of claim 11, wherein cross sections of the scattering microstructures are selected from the group consisting of a triangular form, a rectangular form, a polygonal form, a circular form, a semi-circular form, a sector form and an irregular form.

16. The LCD device of claim 11, wherein the scattering microstructures are of a hollow structure and/or a structure filled with a scattering material.

17. The LCD device of claim 15, wherein the cross-sections of the scattering microstructures are in a sector form, and an apex angle of the sector faces toward the point light source.

18. The LCD device of claim 11, wherein a distribution density of the scattering microstructures is positively correlated with a distance from the point light source.

19. The LCD device of claim 15, wherein the cross sections of the scattering microstructures are in a rectangle form, and a short side of the rectangle faces toward the point light source.
